(19) United States
(12) Patent Application Publication
(10) Pub. No.: US 2019/0179902 A1
(43) Pub. Date: Jun. 13, 2019

(54) SYSTEMS AND METHODS FOR TASK AUTOMATION USING NATURAL LANGUAGE PROCESSING

(71) Applicant: The Procter & Gamble Company, Cincinnati, OH (US)

(72) Inventors: Anshul Ramanand Srivastava, Cincinnati, OH (US); Michele Marie Hughes, Cincinnati, OH (US)

(21) Appl. No.: 16/200,807

(22) Filed: Nov. 27, 2018

Related U.S. Application Data
(60) Provisional application No. 62/595,680, filed on Dec. 7, 2017.

(51) Int. Cl. G06F 17/27; G06F 9/50; G06F 21/31

(52) U.S. Cl. CPC G06F 17/2785; G06F 21/31; G06F 9/50

(57) ABSTRACT

A system comprising a network environment including a user interface and an automated task application or “bot”. The system further comprises a memory and processing component comprising programming executable to perform the steps of: receiving natural language input from a user; providing electronically coded data associated with the natural language; sending the electronically coded data to a set of child bot applications; receiving child bot application responses comprising an answer and a confidence score; determining a winning child bot response; and providing the winning child bot answer to the user.

### FIELD OF THE INVENTION

The invention relates to computer systems and methods for the automation of tasks using natural language processing. The invention relates particularly to systems and methods for task automation using natural language processing through a master orchestration layer.

### BACKGROUND OF THE INVENTION

Natural language processing (NLP) is well known in the art. Typical NLP systems are capable of receiving spoken or written natural language input and converting that input into an electronically process able form to trigger a task associated with the interpreted meaning. Automated systems, which receive either the NLP input or output and act upon the received data based upon the programming and or training of the system, are also known. Typical automated systems have a master layer comprising the knowledge of the system. The master layer is programmed or trained to respond to NLP data and to provide a response to a user. Programming and training such a system to a level wherein the knowledge and capabilities of the system represent a true benefit to the user is time and resource intensive. Typical systems lack any means to interact with their environment and leverage capabilities beyond themselves to increase their utility. What is needed are systems and methods which can leverage the capabilities of the environment to provide an expanded degree of task automation beyond the initial programming and knowledge of the system.

### SUMMARY OF THE INVENTION

In one aspect, a system comprises a network environment comprising a user interface and an automated task application or “bot”. The system further comprises a memory and processing component comprising programming executable to perform the steps of: receiving natural language input from a user; providing electronically coded data associated with the natural language; sending the electronically coded data to a set of child bot applications; receiving child bot application responses comprising an answer and a confidence score; determining a winning child bot response; and providing the winning child bot answer to the user.

In one aspect a method for automating tasks using natural language processing includes steps of: receiving natural language input from a user; providing electronically coded data associated with the natural language; sending the electronically coded data to a set of child bot applications; receiving child bot application responses comprising an answer and a confidence score; determining a winning child bot response; and providing the winning child bot answer to the user.

In one aspect, a system comprises a network environment comprising a user interface and an automated task application or “bot”. The system further comprises a memory and processing component comprising programming executable to perform the steps of: receiving natural language input from a user; providing electronically coded data associated with the natural language; sending the electronically coded data to a set of child bot applications; receiving child bot application responses comprising an answer and a confidence score; determining a winning child bot response; providing the winning child bot answer to the user; storing the natural language input and winning child bot response in a conversation database; receiving new natural language input from a user; matching the new natural language input with natural language input stored in the conversation database; sending the new user natural language input only to the winning child bot associated with the matched natural language input from the conversation database; receiving a new response from the winning child bot; and sending the new winning child bot answer to the user.

### DETAILED DESCRIPTION OF THE INVENTION

As used herein, the terms: “a”, and “an” refer to a singular instance of the referenced object while also not limiting any disclosed combination to a single instance of the referenced object.

The software necessary to implement the methods of the invention may reside on a stand-alone device such as a cell phone, a tablet, a laptop or desktop computer, a standalone voice controlled smart device that may be on its own or part of another hardware eg. IoT device etc., may reside on-premise (on-prem) or may reside as a cloud based service and be provided to devices through a client application over a network connect. Exemplary cloud platforms include: AZURE® from Microsoft Corp, Redmond, Wash., Amazon Web Service (AWS) available from Amazon.com, Seattle, Wash. The application may be made accessible through SMS, email, voice control, mobile apps, and messaging applications such as SKYPE®, SLACK®. In one embodiment, a user interface which is relatively small in terms of the computational resources necessary for it to function, may reside on a user's network capable device while the substantial and computational intensive portions of the system of the method may reside on network resources including cloud based resources.

In one embodiment, the user interface may be dynamically customized based upon information stored in a user's profile. Information including the user's identity, location, language, organization, and function within a particular organization may be used to identify the set of options and information revealed in the user interface as well as being used to select the network resources including software applications available to the particular user. The user interface may be further customized according to the device and channel used by the user for accessing the systems and methods.

In one embodiment, the user interface may be personalized in terms of the appearance, color and theme of the interface. The ongoing activities of each user may be tracked as part of the user profile and this profile may be used by the master application to identify topics for presentation to the user as well as providing a usable history of travel and scheduling preferences for the user.

The computer implemented instructions may be coded using any appropriate language including: C++, Node js, or JAVA®. Databases associated with the method may be implemented using SQL, RDBMS or other database formats.

The method of the invention may be practiced in association with any suitable operating system including: the Apple iOS®, Android®, and WINDOWS® operating systems. In one embodiment, the method may be accessed using web browsing applications.

In one embodiment, a method for task automation utilizing natural language processing includes receiving natural language input from a user. The input may be spoken or written by the user and sent to the system of the method by keyboard entry or microphone. The received input may be received by a master level application and processed using Natural Language Processing (NLP) software utilities resulting in an electronically processable translation of the original natural language input. Exemplary NLP utilities include: NLPU.

In one embodiment, the user may be authenticated by the system of the method. The authentication may be accomplished using OAuth2 or SAML, using standard or customized databases for the authentication. Additional authentication may be undertaken to satisfy the requirements of a specific downstream bot.

In one embodiment, the channel of the user may be detected, whether that channel be the world-wide web, the internet in general, SMS, SKYPE FOR BUSINESS®, Microsoft TEEMS®, or a voice enabled channel.

In some instances, such as a simple greeting response, the master level application may respond directly to the user. In more complex instances, the master level application may send the NLP output to a set of bots in the network environment. The set may include “n” bots wherein n ranges from 1 to well over 100,000 bots, depending upon the network environment. The bots may each be registered in the environment. The data passed to the bot may further include: a user identifier, type of device or channel used, and a conversation id. The data may be passed using REST or SOAP APIs, or other standard communication protocols.

The bot registration may include: type of bot, bot name, bot utterances, type of data handled, domain and sub-domain, connection and conversation termination details, bot owner and contact details.

In one embodiment, child bots are independent entities that handle their own NLU (natural language understanding) and NLP (natural language processing), processing logic and code including work flows, answers, interface with transactional and database systems using application processing interface (API) based on the NLU input from the user. The child bots include their own code for managing responses in text format, adding additional data like embedded hyperlinks, audio and video files, documents, images, pdf files etc.

In one embodiment, the master level sends the output directly to the set of child bots and receives response directly from the child bots. In one embodiment, the master level sends the output to a service bus which in turn sends the output to the set of bots. Each bot may reply with an answer to the sent input as well as identifying information for the bot, relating the child bot to its registration and the information captured there, as well as a confidence score associating the provided answer with the input. The provided answer may comprise text, audio, video, hyperlinks, images, depending upon the bot type and the initial query. The child bots may respond directly to the master level bot, or the child bots may respond to the service bus of the system.

In one embodiment, the input may be sent to one or more language translation utility bots. The input may be translated from the original language to one or more secondary languages. The translated input may be sent to one or more registered bots specifying a particular language different from the original input language (the foreign language bots). In this embodiment, the response received from the foreign language bots may be reverse translated into the original language such that the user may be sent a response in the original language. This embodiment may be practiced for systems which include the service bus element and also in systems which do not include the service bus element. Exemplary language translation utilities include: Microsoft Translator Text API® available from Microsoft. Any utterances or conversation stored in this embodiment may be stored in English.

In one embodiment, the set of registered bots may include external master bots. Exemplary external master bots include: ALEXA® from Amazon.com, SIRI®, from Apple, Inc., Google HOME® and CORTANA®, from Microsoft.

In one embodiment, the set of bots may include bots associated with or controlling Internet of Things (IoT) devices available to the user. In this embodiment, the master bot may enable the user to query the status of the IoT device as well as interact and control the devices.

The set of received responses may be ranked according to their respective bot confidence scores. The ranking may be accomplished by the service bus, by the master bot, or by a decision engine provided for this purpose, depending upon the specific architecture of the system being used. The winning bot answer may be sent from the master bot to the user. The format of the winning response may be altered to conform the response to the requirements of the user's channel or device.

In one embodiment, multiple response may tie as the winning response. In this embodiment, the multiple responses may each be presented to the user who may select among them to determine the final winning response.

In one embodiment, as or after the user receives the wining response, the user may provide additional input indicating that the response was not adequate. In this embodiment, the master level bot may resend the initial query to the set of bots for a new set of responses from the child bots.

The winning child bot response may signify the beginning of a conversation rather than a simple answer to a question followed by a terminator. In this embodiment, the system of the method, either the service bus of the master bot in systems where there is no service bus, will latch onto the winning bot to continue the conversation between the child bot and the user until a conversation terminator is received from either the user or the child bot. During the conversation, the master bot will send bot response to the user and return user responses to the bot until the conversation is complete and a conversation terminator is received. In one embodiment, REDIS may be used to maintain the connection between the child bot and the user.

In one embodiment, the master bot may direct the user to an application providing direct contact with a live agent rather than an automated application. The master bot may take this step upon evaluating the user input and recognizing it as a request for an agent. In this embodiment, the master bot may function as the interface between the user and the agent.

In one embodiment, the data for each conversation: user data including identification data, channel data, and user input string, together with the data regarding the winning response: winning child bot, winning content, and bot data, may be stored in a conversation data base accessible by the master bot, either directly or via the service bus, or the rule engine. Subsequent inputs from the same user of other users served by the same master bot may then be compared to data base entries before being sent to the set of child bots. In this embodiment, when there is a match between the new input and the input in one or more data base entries, the complete data base entry may then be reviewed to simplify the remaining portion of the process by providing an indication of a particular child bot to send the new input to rather than sending the input to all registered child bots. In simple conversation instances, the data base may provide an indication of a winning answer to the input query without the need for sending the input to any child bots. In this embodiment, the master bot together with the conversation data base may become increasingly proficient at responding to input queries from users in terms of reducing the time necessary to respond to a reduced set of child bots queried, as well as responding directly to a greater range of user inputs due to the growing collection of previously successful responses captured in the conversation data base.

In one embodiment, feedback mechanisms may log user and response utterances, identify untrained utterances, track winning utterances and map utterances to user intents and responding entities using vocabulary analysis tools.

In one embodiment, the conversation database comprises conversations for each user and may provide a basis for rule based response categorization according to user profile such that similar queries will yield different winning responses according to the differences in the user profiles.

In one embodiment, the conversation database enables the provision of conversation transcripts to users and system administrators for review and analysis. Automated analysis of the conversations over time may enable the master application software to offer content suggestions to users by recognizing patterns in the winning responses according to users.

In one embodiment, the conversation data base enables the association of particular inputs with sequences of subsequent queries and the master applications software may offer content to a new user based upon a single input tied to a chain of subsequent inputs by the history collected for other users.

The system may capture user information necessary for authentication of a user and may subsequently provide this information automatically when prompted by a child bot rather than passing the request back to the user and subsequently passing the repeatedly entered information to the child bot. The information may be stored in an encrypted fashion in the user profile or the conversation data base.

In one embodiment, the system may track the user in a single conversation as the user changes devices and channels. In this embodiment, the conversation data base and user profile may be linked to enable the following of the user as these changes occur.

In one embodiment, the conversation data base allows the system to associate users with events displaced in time or by information needs and to subsequently push notifications associated with the event to the relevant users as the status of the events changes due to computational progress or the passage of time.

In one embodiment, the performance of the method may be analyzed using a performance dashboard. The dashboard may include a display of the user sentiment toward the conversation analyzed in real time as the conversation occurs. This analysis enables the method to evaluate conversations to weigh the relative effectiveness of different response streams to similar queries. The real-time sentiment analysis may be obtained using standard sentiment analysis through an API to the cloud based sentiment analysis. Exemplary sentiment analysis software is available from Amazon Web Service, Microsoft, and Google.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for task automation utilizing natural language processing, the method comprising steps of:
a. Receiving natural language input from a user;
b. providing electronically coded data associated with the natural language;
c. sending the electronically coded data to a set of child bot applications;
d. receiving child bot application responses comprising an answer and a confidence score;
e. determining a winning child bot response;
f. providing the winning child bot answer to the user.

2. The method according to claim 1 further comprising the step of:
a. Authenticating the user.

3. The method according to claim 1 further comprising the step of:
a. Detecting the channel of the user.

4. The method according to claim 1 further comprising the step of:
a. Formatting the winning response to a required user experience.

5. The method according to claim 1 further comprising the steps of:
a. Receiving from the user an indication that the winning response is not adequate; and
b. Resending the natural language input to the set of child bots.

6. The method according to claim 1 further comprising the step of latching with the winning child bot.

7. The method according to claim 6 further comprising the steps of:
a. Maintaining contact with the child bot;
b. Passing child bot queries to the user;
c. Passing user query responses to the child bot;
d. Disabling contact with the child bot after receipt of a conversation terminator from the user or the child bot.

8. The method according to claim 1 wherein the steps of passing the electronically coded data to a set of child bots and receiving child bot application responses comprising an answer and a confidence score comprises steps of:
a. Passing the electronically coded data to a service bus;
b. Passing the electronically coded data from the service bus to a set of child bots;
c. Receiving child bot responses comprising an answer and a confidence score at the service bus.

9. The method according to claim 1 wherein the step of determining a winning child bot response based upon a confidence score comprises steps of:
a. Receiving the child bot responses at a rule engine;
b. Ranking the received child bot responses according to confidence score;
c. Defining the response having the highest confidence score as the winning response.

10. The method according to claim 1 further comprising steps of:
a. Responding directly to a user natural language greeting.

11. The method according to claim 1 further comprising the step of:
a. Providing the user an option to connect to a live agent application;
b. Receiving from the user a request to connect to a live agent application;
c. Connecting the user to a live agent application;
d. Serving as an interface between the live agent and the user;
e. Disabling contact with the agent as or after receiving a conversation terminator from the agent or the user and being ready to receive the next set of user input.

12. The method according to claim 1 further comprising the steps of:
a. Providing the user a winning response which comprises an embedded hyperlink.

13. A method for task automation utilizing natural language processing, the method comprising steps of:
a. receiving natural language input from a user;
b. providing electronically coded data associated with the natural language;
c. passing the electronically coded data to a set of child bot applications;
d. receiving child bot application responses comprising the child bot identity, child bot type, an answer and a confidence score;
e. determining a winning child bot response based upon the confidence score;
f. providing the winning child bot answer to the user.
g. Storing the natural language input and winning child bot response in a conversation database;
h. Receiving new natural language input from a user;
i. Matching the new natural language input with natural language input stored in the conversation database;
j. Passing the new user natural language input only to the winning child bot associated with the matched natural language input from the conversation database;
k. Receiving a new response from the winning child bot;
l. Passing the new winning child bot answer to the user.

14. The method according to claim 13 further comprising the step of latching with the winning child bot.

15. The method according to claim 14 further comprising the steps of:
a. Maintaining contact with the child bot;
b. Passing child bot queries to the user;
c. Passing user query responses to the child bot;
d. Disabling contact with the child bot after receipt of a conversation terminator from the user or the child bot.

16. The method according to claim 13 wherein the steps of passing the electronically coded data to a set of child bots and receiving child bot application responses comprising an answer and a confidence score comprises steps of:
a. Passing the electronically coded data to a service bus;
b. Passing the electronically coded data from the service bus to a set of child bots;

17. The method according to claim 13 wherein the step of determining a winning child bot response based upon a confidence score comprises steps of:
a. Receiving the child bot responses at a rule engine;
b. Ranking the received child bot responses according to confidence score;
c. Defining the response having the highest confidence score as the winning response.

18. The method according to claim 13 further comprising steps of:
a. Responding directly to a user natural language greeting.

19. The method according to claim 13 further comprising the steps of:
a. Providing the user an option to connect to a live agent application;
b. Receiving from the user a request to connect to a live agent application;
c. Connecting the user to a live agent application;
d. Serving as an interface between the live agent and the user;
e. Disabling contact with the agent as or after receiving a conversation terminator from the agent or the user and being ready to receive the next set of user input.

20. The method according to claim 13 further comprising the step of:
a. Providing the user a winning response which comprises an embedded hyperlink.
